(19) United States
(12) Patent Application Publication
(10) Pub. No.: US 2026/0318006 A1
(43) Pub. Date: Oct. 15, 2026

(54) Papers Having High Dielectric Strength, High Average Specific Modulus, and High Density

(71) Applicant: DUPONT SAFETY & CONSTRUCTION, INC., WILMINGTON, DE (US)

(72) Inventors: MEHDI AFSHARI, MIDLOTHIAN, VA (US); BYOUNG S. KANG, MIDLOTHIAN, VA (US); DARIUSZ W. KAWKA, MIDLOTHIAN, VA (US); CHRISTOPHER WAYNE SEAY, MOSELEY, VA (US); BARBARA LYNNE WISEMAN, RICHMOND, VA (US)

(21) Appl. No.: 19/243,297

(22) Filed: Jun. 19, 2025

Related U.S. Application Data
(60) Provisional application No. 63/663,391, filed on Jun. 24, 2024.

(51) Int. Cl. D21H 13/20; D21F 1/66; D21F 3/08; D21H 17/56

(52) U.S. Cl. CPC D21H 13/20; D21F 1/66; D21F 3/08; D21H 17/56

(57) ABSTRACT

A paper comprising polymeric fibers and polymeric binder, the polymeric fibers comprising a first polymer that is a copolymer having a structure derived from the reaction of para-oriented aromatic diamine monomer and benzimidazole monomer with a para-oriented aromatic diacid monomer, and the polymeric binder comprising a second polymer that is a copolymer having a structure derived from the reaction of para-oriented aromatic diamine monomer and benzimidazole monomer with a para-oriented aromatic diacid monomer, the paper having a dielectric strength of 12.0 kV/mm or greater, an average specific modulus of 8000 Pa-m³/g or higher, and a density of 0.75 grams per cubic centimeter or greater.

### BACKGROUND OF THE INVENTION

Field of the Invention. This invention is directed to synthetic papers that have an unexpected and useful combination of properties, namely high dielectric strength, high stiffness as represented by specific modulus, and high density; the papers also have good thermal properties; that is, they resist degradation at elevated temperatures. Such synthetic papers can be used as electrical insulation and in other applications, such as structural cores.

Description of Related Art Synthetic papers are disclosed in references such as U.S. Pat. No. 2,999,788 to Morgan and U.S. Pat. No. 3,756,908 to Gross. These patents disclose the making of synthetic papers using various polymeric fibrids as polymeric binders combined with short fibers, normally referred to as floc. U.S. Pat. No. 4,729,921 to Tokarsky discloses preparation of aramid papers using aramid floc, aramid fibrids, and, optionally, aramid pulp. The papers are said to be useful in circuit boards. U.S. Pat. No. 5,137,768 to Lin discloses a high shear modulus aramid honeycomb structure; the nonwoven paper used in the honeycomb structure includes a nonwoven paper including a uniform mixture of 0 to 50 weight percent poly(m-phenylene isophthalamide) (MPD-I) fibrids; 50 to 100 weight percent poly(p-phenylene terephthalamide) (PPD-T) fibers, and a solid matrix resin uniformly distributed throughout the paper such that the para-aramid fibers represent 20 to 80% of the total volume of the impregnated core material.

Fibers derived from the para-oriented aromatic diamine monomer para-phenylenediamine (PPD), the benzimidazole monomer 5(6)-amino-2-(p-aminophenyl) benzimidazole (DAPBI), and the para-oriented aromatic diacid monomer terephthaloyl dichloride (TCL) are known in the art for producing a high tenacity yarn for use in ballistic applications. Such fibers can be made by spinning the copolymer directly from the polymerization solution, such as exemplified for high strength Russian fibers sold under the trade names such as Armos® and Rusar®. (See Russian Patent Application No. 2,045,586.) Preferably, however; after copolymerization, the copolymer can be isolated from the polymerization solvent and then redissolved in another solvent, typically sulfuric acid, to solution spin fibers, such as shown in, for example, in Sugak et al., Fibre Chemistry Vol 31, No 1, 1999; U.S. Pat. No. 4,018,735; and in recent patent publications WO2008/061668 and WO2013/105948.

The tensile modulus or Young's modulus per mass density of a material is known as the stiffness to weight ratio or specific modulus. As papers can have directionality, the average specific modulus of a paper is the calculated average of the specific modulus in the machine direction and the specific modulus in the cross direction; the machine direction being parallel to the paper manufacturing method (machine), and the cross direction being orthogonal or transverse to the machine direction in the same plane.

The dielectric strength of a material is measured in volts per unit thickness and is the maximum electrical field that the material can withstand before failure of its insulating properties. The voltage at which the material experiences this electrical breakdown, losing its ability to electrically insulate, is called the breakdown voltage. Electrical insulation having high dielectric strength and high stiffness is highly desirable in some electrical insulation applications; for example, as in the high speed insertion of slot liner insulation into slots of stators to insulate the windings from the stator. In other applications such as composites or core structures (i.e., honeycombs, etc.), papers having high average specific modulus and high density are desirable. Therefore, a sheet material such as a paper having high dielectric strength, high stiffness, and high density would be desirable.

### BRIEF SUMMARY OF THE INVENTION

This invention relates to a paper comprising fibers, and polymeric binder, the polymeric fibers comprising a first polymer and the polymeric binder comprising a second polymer, wherein the first polymer is a copolymer having a structure derived from the reaction of para-oriented aromatic diamine monomer and benzimidazole monomer with a para-oriented aromatic diacid monomer, and wherein the second polymer is a copolymer having a structure derived from the reaction of para-oriented aromatic diamine monomer and benzimidazole monomer with a para-oriented aromatic diacid monomer, the paper having a dielectric strength of 12.0 kV/mm or greater, an average specific modulus of 8000 Pa-m³/g or higher, and a density of 0.75 grams per cubic centimeter or greater.

This invention also relates to a process for making a paper, comprising the steps of
a) forming an aqueous slurry comprising polymeric fibers comprising a first polymer and polymeric binder comprising a second polymer, wherein the first polymer is a copolymer having a structure derived from the reaction of para-oriented aromatic diamine monomer and benzimidazole monomer with a para-oriented aromatic diacid monomer, and the polymeric fibers have a 2 theta (2θ) x-ray diffraction angle peak of 25 (+/−0.5) degrees, and wherein the second polymer is a copolymer having a structure derived from the reaction of para-oriented aromatic diamine monomer and benzimidazole monomer with a para-oriented aromatic diacid monomer;
b) removing water from the slurry on a paper machine to form a wet paper composition;
c) drying the wet paper composition to form a dried sheet; and
d) thermally consolidating the dried sheet in one or more steps between nipped rolls heated to a surface temperature of 260° C. or more, using a nip pressure of 700 to 5000 lbs./inch (125 to 894 kg/cm);
to form a paper having a dielectric strength of 12.0 kV/mm or greater, an average specific modulus of 8000 Pa-m³/g or higher, and a density of 0.75 grams per cubic centimeter or greater.

### BRIEF DESCRIPTION OF THE DRAWINGS

FIG. 1 is an illustration of a representative x-ray diffraction angle tracing of either a paper and fiber having a 2 theta (2θ) x-ray diffraction angle peak at 25 (+/−0.5) degrees as designated by 1; and a representative x-ray diffraction angle tracing of paper and fiber having a 2 theta (2θ) x-ray diffraction angle peak at 20.2 (+/−0.5) degrees as designated by 2.

### DETAILED DESCRIPTION OF THE INVENTION

This invention is directed to papers having very high dielectric strength, high density, and high stiffness as represented by high average specific modulus. The papers comprise polymeric fibers and polymeric binder.

By paper, it is meant a planar sheet, made from one or more plies or layers of polymeric fibers incorporating a polymeric binder, that is prepared by paper-making processes; the polymeric fibers can be in the form of fibers, floc, or pulp. Such paper-making processes typically involve depositing an aqueous slurry or dispersion of fibrous material (preferably both fibers and binder) on a screen or mesh to form one or more fibrous layer(s) or ply(plies) and removing liquid to form a de-watered sheet. Representative devices and machinery that can be used to make plies or layers include continuous-processing equipment such as, for example without limitation to, a Fourdrinier, inclined wire, or other papermaking machine; or batch-processing equipment that, for example, makes a paper in a sheet mold containing a forming screen. The de-watered sheet is then typically dried on the surface of drying cans or in an oven to make the sheet a formed paper. This formed paper is also known as “uncalendered paper”.

As used herein, formed paper or uncalendered paper is a planar sheet that has not been exposed to temperatures of 260° C. or higher. This formed or uncalendered paper generally does not have high strength properties; therefore, uncalendered paper is then typically thermally consolidated with heat and pressure to form bonds or linkages between the fibrous materials in the paper. This thermal consolidation can be done by pressing the dried sheet between two surfaces maintained at a high temperature, such as in a heated plate press; but for practical commercial production, the thermal consolidation can be performed in a continuous manner by pressing the dried sheet in the nip between two heated rolls. This process is known as calendering, and the rolls are known as calendering rolls. Thermally consolidated paper is therefore made by the application of high pressure and heat as described herein, by some sort of process such as by use of a heated press or heated set of calender rolls. As used herein, a “thermally consolidated” or “calendered” paper is a planar sheet that has been exposed to 260° C. or higher under a pressure of at least 700 lbs./inch (125 kg/cm); and further, the terms “calendered paper” and “thermally consolidated paper” are used interchangeably herein. It is understood that several plies with the same or different compositions can be combined together into the final paper structure during forming and/or calendering.

“Polymeric fiber” means fiber made from a polymer or copolymer. “Fiber” means a relatively flexible, unit of matter having a high ratio of length to width across its cross-sectional area perpendicular to its length. Herein, the term “fiber” is used interchangeably with the term “filament”. The cross section of the filaments described herein can be any shape but are typically circular or bean shaped. Fibers or filaments spun onto a bobbin in a package without any prior cutting is referred to as continuous fiber. Fiber can be cut into short lengths called staple fiber. Fiber can be cut into even smaller lengths called floc.

The preferred polymeric fiber can include floc. The term “floc”, as used herein, means fibers that are cut to a short length and that are customarily used in the preparation of papers. Typically, floc has a length of from about 3 to about 20 millimeters. A preferred length is from about 3 to about 7 millimeters. Floc is normally produced by cutting continuous fibers into the required lengths using well-known methods in the art.

The polymeric fiber can include pulp. “Pulp” as used herein comprises fibrillated fibrous structures, which are particles of material having a stalk, and fibrils extending therefrom; wherein the stalk is generally columnar and about 10 to 50 microns in diameter and the fibrils are hair-like members only a fraction of a micron or a few microns in diameter attached to the stalk and about 10 to 100 microns long.

The paper comprises polymeric fibers comprising a first polymer, wherein the first polymer is a copolymer having a structure derived from the reaction of para-oriented aromatic diamine monomer and benzimidazole monomer with a para-oriented aromatic diacid monomer. In some preferred embodiments, the copolymer is an aramid copolymer including a benzimidazole group.

The terms “polymer” or “copolymer” as used herein, mean a material prepared by polymerizing monomers, end-functionalized oligomers, and/or end-functionalized polymers whether of the same or different types. The term aramid, as used herein, means aromatic polyamide, wherein at least 85% of the amide (—CONH—) linkages are attached directly to two aromatic rings.

The term “aramid copolymer including a benzimidazole group” as used herein refers to copolymers polymerized from aromatic diacid monomers and aromatic diamine monomers, wherein there are at least two different aromatic diamine monomers present; preferably a para-aromatic diamine monomer and a benzimidazole monomer. The two different aromatic diamine monomers can be polymerized with a stoichiometric amount of at least one para-oriented aromatic diacid monomer. By “copolymer” it is meant the monomers are copolymerized in some fashion to form individual polymer chains having residues of the para-oriented aromatic diamine monomer, the benzimidazole monomer, and the para-oriented aromatic diacid monomer. In some embodiments, the monomers form a random copolymer; that is, the para-oriented aromatic diamine monomer and benzimidazole monomer residues are located randomly in the polymer chain.

In some embodiments, the para-oriented aromatic diamine is paraphenylene diamine. Other para-oriented aromatic diamines are possible. In some embodiments, the benzimidazole is 5(6)-amino-2-(p-aminophenyl) benzimidazole (DAPBI). Other benzimidazoles are possible. In some embodiments, the para-oriented aromatic diacid is terephthaloyl dichloride. Other para-oriented aromatic diacids are possible. In some preferred embodiments, the aramid copolymer is made by polymerizing the monomers 5(6)-amino-2-(p-aminophenyl) benzimidazole, one or more para-aromatic diamine(s), and one or more para-aromatic diacid-chloride(s). In some most preferred embodiments, the aramid copolymer is made by polymerizing the specific monomers 5(6)-amino-2-(p-aminophenyl) benzimidazole, paraphenylene diamine, and terephthaloyl dichloride.

In some embodiments, the molar ratio of benzimidazole monomer, such as 5(6)-amino-2-(p-aminophenyl) benzimidazole, to the para-aromatic diamine monomer, such as paraphenylene diamine, is 50/50 to 80/20, and in some embodiments the molar ratio is 50/50 to 70/30. In some embodiments, the benzimidazole monomer is 50 mole percent or greater of the total moles of benzimidazole and the para-aromatic diamine present.

In some specific embodiments, the aramid copolymer including a benzimidazole group includes a residue of 5(6)-amino-2-(p-aminophenyl) benzimidazole and a residue of paraphenylene diamine, wherein the molar ratio of the residue of 5(6)-amino-2-(p-aminophenyl) benzimidazole to the residue of paraphenylene diamine is 50/50 to 80/20. In some specific embodiments, the aramid copolymer including a benzimidazole group includes a residue of 5(6)-amino-2-(p-aminophenyl) benzimidazole and a residue of paraphenylene diamine, wherein the molar ratio of the residue of 5(6)-amino-2-(p-aminophenyl) benzimidazole to the residue of paraphenylene diamine is 50/50 to 70/30. In still other embodiments, the residue of the benzimidazole, such as 5(6)-amino-2-(p-aminophenyl) benzimidazole, is 50 mole percent or greater of the total moles of benzimidazole and the para-aromatic diamine residues.

As used herein, “stoichiometric amount” means the amount of a component theoretically needed to react with all of the reactive groups of a second component. For example, “stoichiometric amount” refers to the moles of terephthaloyl dichloride needed to react with substantially all of the amine groups of the amine components. It is understood by those skilled in the art that the term “stoichiometric amount” refers to a range of amounts that are typically within 10% of the theoretical amount. For example, the stoichiometric amount of terephthaloyl dichloride used in a polymerization reaction can be 90-110% of the amount of terephthaloyl dichloride theoretically needed to react with all of the amine groups.

In some embodiments, all of monomers can be combined together and reacted to form the polymer or copolymer. In some embodiments, the monomers or various amounts of the monomers can be reacted sequentially to form oligomers which can be further reacted with additional monomer(s) or oligomer(s) to form polymers or copolymers. By “oligomer,” it is meant polymers or species eluting out at <3000 MW with a column calibrated using poly(paraphenylene terephthalamide) homopolymer.

As used herein, the term “residue” of a chemical species refers to the moiety that is the resulting product of the chemical species in a particular reaction scheme or subsequent formulation or chemical product, regardless of whether the moiety is actually obtained from the chemical species. Thus, a copolymer comprising residues of paraphenylene diamine refers to a copolymer having one or more units of the formula:

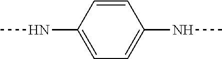

And a copolymer having residues of terephthaloyl dichloride contains one or more units of the formula:

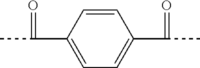

Similarly, a copolymer comprising residues of a benzimidazole contains one or more units of the formula:

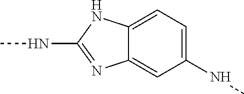

And specifically, a copolymer comprising residues of DAPBI contains one or more units of the formula:

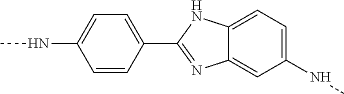

Therefore, in some embodiments, the aramid copolymer includes a residue of a benzimidazole, and in some embodiments the aramid copolymer includes a residue of 5(6)-amino-2-(p-aminophenyl).

After copolymerization, the copolymer can preferably be isolated from the polymerization solvent and then redissolved in another solvent, typically sulfuric acid, to form a polymer solution suitable for spinning fibers. Preferably, polymeric fibers are spun from the polymer solution, preferably via air-gap or dry-jet spinning into a coagulation bath to remove the solvent, followed by processing steps that can include various treatment steps, including washing, drying, drawing, and heat treating steps, to develop the desired high tenacity.

In particular, it is known that to attain yarns having the highest yarn tenacity and highest yarn modulus, the fiber has to be exposed to a temperature above the glass transition temperature of the polymer, a temperature that is normally chosen to be 260° C. or higher. Such fibers that have been exposed a temperature of 260° C. or higher to are referred to herein as “heat-treated” fibers.

Fibers that have not been exposed to a temperature of 260° C. or higher are referred to herein as “dried fibers”. Therefore, “dried fibers” have only been exposed to temperatures lower than 260° C. prior to their use in papermaking. The term “dried fibers” is used because the drying of the fiber is a typical processing step that might expose the fibers to some heat prior to any heat treating step of about 260° C. or greater.

Further, while the dried fibers have much lower tenacity and tensile modulus than the heat treated fibers, it has been found that when heat-treated fiber yarns and dried fiber yarns are cut into floc, and each separately used to make thermally-consolidated paper, the thermally-consolidated paper made with the lower tenacity/lower modulus dried fibers have surprisingly high dielectric strength, high density, and high stiffness as represented by high average specific modulus.

Both the dried and heat-treated polymeric fibers, when used to make formed papers, preferably have a relatively round or solid-circular cross-section prior to any thermal consolidation of the dried sheet. It is believed, however, that if the dried sheet is made with “dried fibers” as defined herein, and is then thermally consolidated under heat and pressure, the majority of the dried fibers in the thermally consolidated paper are deformed or flattened, which contribute to the surprising properties of this inventive paper. It is further believed that if the dried sheet is made with “heat treated fibers” as defined herein, and is then thermally consolidated under heat and pressure, the majority of the heat treated fibers retain their round structure, which contributes the dramatically lower density exhibited by those thermally consolidated papers. It is believed that since the heat treated fibers have already been exposed to temperatures of 260° C. or higher, which increases their crystallinity prior to paper making, the heat treated fibers better retain their round fiber structure when the paper is subsequently consolidated with heat and pressure. Since the dried fibers have not been exposed to such temperatures, these dried fibers are more deformable when the paper is subsequently consolidated with heat and pressure, providing a paper that has a surprising combination of high dielectric strength, high average specific modulus, and high density.

The paper comprises polymeric binder comprising a second polymer. By “polymeric binder” it is meant a binding agent having some polymeric nature that effectively binds together at least some parts of the polymeric fibers together in the sheet. The inclusion of polymeric binder typically increases the strength and other properties of the paper. The polymeric binder is preferably activated by the application of heat and pressure.

Like the first polymer, the second polymer is a copolymer having a structure derived from the reaction of para-oriented aromatic diamine monomer and benzimidazole monomer with a para-oriented aromatic diacid monomer.

In some embodiments, the second polymer can have one or more of the same specific monomers as the first polymer or aramid copolymer previously described herein; and the specific aramid copolymer monomers can be present in the same molar ratios and amounts and residues as previously discussed herein. In some embodiments, the benzimidazole monomer of the second polymer is 5(6)-amino-2-(p-aminophenyl) benzimidazole. In some embodiments, the second polymer further comprises a para-oriented diamine monomer that is paraphenylene diamine, and in some embodiments the para-oriented aromatic acid monomer is terephthaloyl dichloride. In some preferred embodiments, the second polymer is the same as the first polymer. In some preferred embodiments, the monomers of both the first and second polymers is as follows; the benzimidazole monomer is 5(6)-amino-2-(p-aminophenyl) benzimidazole, the para-oriented diamine monomer is paraphenylene diamine, and the para-oriented aromatic acid monomer is terephthaloyl dichloride. The molar ratio of the monomers in the first and second polymer can be different; however, in some preferred embodiments both the first polymer and the second polymer have the same the molar ratio of the residue of 5(6)-amino-2-(p-aminophenyl) benzimidazole to the residue of paraphenylene diamine. In a preferred embodiment, the sole binder in the paper is the polymeric binder made with the second polymer.

In some preferred embodiments, the polymeric binder can be in the form of fibrids. The term “fibrids”, as used herein, means very small, nongranular, fibrous or film-like particles, with at least one of their three dimensions being of minor magnitude relative to the largest dimension. These particles can be prepared by precipitation of a solution of polymeric material using a non-solvent under high shear. Representative of such known methods include using an apparatus such as disclosed in U.S. Pat. No. 3,018,091.

Fibrids generally have a largest dimension length in the range of about 0.1 mm to about 1 mm with a length-to-width aspect ratio of about 5:1 to about 10:1. The thickness dimension is on the order of a fraction of a micron, for example, about 0.01 to about 1.0 micrometer. While not required, it is preferred to incorporate aramid fibrids into the paper during paper forming while the fibrids are in a never-dried state. For example, the wet fibrids, before being dried, can be incorporated into a headbox slurry and deposited on a screen with the polymeric binder physically entwined with and about the floc component of the laid paper.

In some embodiments, the polymeric binder of the paper includes non-granular polymer fibrids that are fibrous, film-like or a mixture thereof, made from the second polymer as described herein. Preferred fibrids are non-granular film-like particles of aramid copolymer including a benzimidazole group having a melting point or decomposition point above 320° C. Preferably, the fibrids have residues of a benzimidazole monomer, such as 5(6)-amino-2-(p-aminophenyl) benzimidazole; a para-oriented diamine monomer, such as paraphenylene diamine; and a para-oriented aromatic acid monomer, such as terephthaloyl dichloride.

The thermally consolidated paper has a dielectric strength of 12.0 kV/mm or greater. In some embodiments, the thermally consolidated paper has a dielectric strength of 13.0 kV/mm or greater. In some embodiments, the thermally consolidated paper has a dielectric strength of 21.0 kV/mm or less. In some embodiments, the thermally consolidated paper has a dielectric strength of 20.0 kV/mm or less. In some embodiments, the thermally consolidated paper has a dielectric strength of 12.0 to 21.0 kV/mm, and in some other embodiments, the thermally consolidated paper has a dielectric strength of 13.0 to 20.0 kV/mm.

The thermally consolidated paper has an average specific modulus of 8000 Pa-m³/g or higher. In some embodiments, the thermally consolidated paper has an average specific modulus of 9500 Pa-m³/g or higher. In some embodiments, the thermally consolidated paper has an average specific modulus of 13500 Pa-m³/g or less. In some embodiments, the thermally consolidated paper has an average specific modulus of 12500 Pa-m³/g or less. In some embodiments, the thermally consolidated paper has an average specific modulus of 8000 to 13500 Pa-m³/g, and in some other embodiments, the thermally consolidated paper has an average specific modulus of 9500 to 12500 Pa-m³/g.

The thermally consolidated paper has a density of 0.75 grams per cubic centimeter (g/cm³) or greater. In some embodiments, the thermally consolidated paper has a density of 0.8 g/cm³ or greater. In some embodiments, the thermally consolidated paper has a density of 0.9 g/cm³ or greater. In some embodiments, the thermally consolidated paper has a density of 1.2 g/cm³ or less. In some embodiments, the thermally consolidated paper has a density of 1.1 g/cm³ or less. In some embodiments, the thermally consolidated paper has a density of 0.8 g/cm³ to 1.1 g/cm³, and in some other embodiments, the thermally consolidated paper has a density of 0.9 g/cm³ to 1.1 g/cm³.

The thermally consolidated paper also preferably has the following properties. In some embodiments, the thermally consolidated paper has a density of about 0.750 g/cm³ to 1.5 g/cm³. In some embodiments, the thermally consolidated paper has a density of about 0.75 g/cm³ to 1.25 g/cm³.

In some embodiments, the thermally consolidated paper has a total thickness in both the machine and cross direction of 0.030 to 0.070 mm. In some embodiments, the thermally consolidated paper has a total thickness in both the machine and cross direction of 0.035 to 0.065 mm; preferably a total thickness in both the machine and cross direction of 0.040 to 0.055 mm.

In some embodiments, the thermally consolidated paper has a total basis weight in both the machine and cross direction of 15 to 100 grams per square meter (gsm). In some embodiments, the thermally consolidated paper has a total basis weight in both the machine and cross direction of 25 to 75 gsm; preferably a basis weight in both the machine and cross direction of 30 to 60 gsm. In some embodiments, the paper has polymeric fibers comprising the first polymer and polymeric binder comprising the second polymer, wherein the polymeric fibers comprising the first polymer are at least 40 weight percent of the paper; and in some embodiments, the polymeric fibers comprising the first polymer are at least 45 weight percent of the paper; and in some embodiments, the polymeric fibers comprising the first polymer are at least 50 weight percent of the paper, all said weights based on the combined weight of said polymeric fibers and said polymeric binder in the paper.

In some specific embodiments, the paper has 40 to 90 weight percent of the polymeric fibers comprising the first polymer and 10 to 60 weight percent of the polymeric binder comprising the second polymer, based on the combined weight of said polymeric fibers and said polymeric binder in the paper. In some embodiments, the paper has 45 to 90 weight percent of the polymeric fibers comprising the first polymer and 10 to 55 weight percent of the polymeric binder comprising the second polymer, based on the combined weight of said polymeric fibers and said polymeric binder in the paper. In some embodiments, the paper has 45 to 85 weight percent of the polymeric fibers comprising the first polymer and 15 to 55 weight percent of the polymeric binder comprising the second polymer, based on the combined weight of said polymeric fibers and said polymeric binder in the paper. In some embodiments, the paper has 50 to 80 weight percent of the polymeric fibers comprising the first polymer and 20 to 50 weight percent of the polymeric binder comprising the second polymer, based on the combined weight of said polymeric fibers and said polymeric binder in the paper.

In one preferred embodiment, the paper comprises polymeric fibers comprising a first polymer and polymeric binder comprising a second polymer, wherein both the first polymer and second polymer is a copolymer having a structure derived from the reaction of para-oriented aromatic diamine monomer and benzimidazole monomer with a para-oriented aromatic diacid monomer, and wherein the paper has an x-ray diffraction angle tracing showing a 2 theta (2θ) x-ray diffraction angle peak of 20.2 (+/−0.5) degrees, and the integrated intensity of said x-ray diffraction angle peak is 4 percent or less of the total diffraction pattern intensity, after background subtraction.

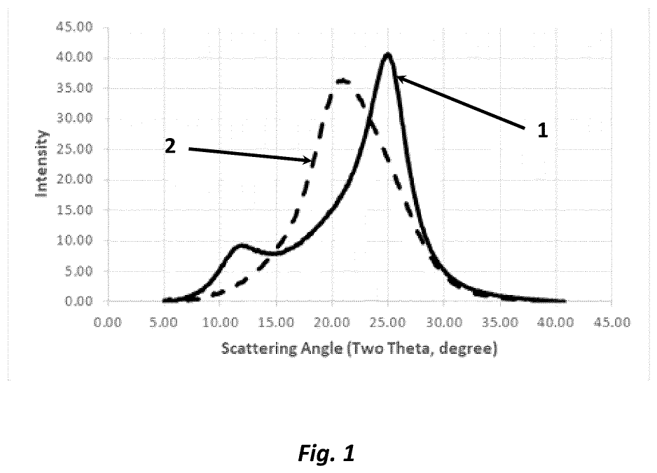

It has been found that an x-ray diffraction angle tracing showing a 2 theta (2θ) x-ray diffraction angle peak of 25 (+/−0.5) degrees, with the integrated intensity of that x-ray diffraction angle peak being 25 percent or more of the total diffraction pattern intensity, after background subtraction, is representative of the previously-described polymeric fibers that have not been exposed to any environment of 260° C. or higher (called dried fibers herein). Tracing 1 of FIG. 1 is an illustration of representative x-ray diffraction angle tracings of paper and fiber having a 2 theta (2θ) x-ray diffraction angle peak at 25 (+/−0.5) degrees. Further, it has been found that when formed papers comprising these dried fibers made from the first polymer; that is, the copolymer described above, and polymeric binder made from the second polymer; that is, the copolymer described above, and are then thermally consolidated or calendered, the resulting papers exhibit a 2 theta (2θ) x-ray diffraction angle peak of 20.2 (+/−0.5) degrees, and the integrated intensity of that x-ray diffraction angle peak is 4 percent or less of the total diffraction pattern intensity, after background subtraction. Tracing 2 of FIG. 1 is an illustration of representative x-ray diffraction angle tracings and of paper and fiber having a 2 theta (2θ) x-ray diffraction angle peak at 20.2 (+/−0.5) degrees.

This is in contrast with the previously described heat-treated polymeric fibers, which exhibit an x-ray diffraction angle tracing showing a 2 theta (2θ) x-ray diffraction angle peak of 20.2 (+/−0.5) degrees, wherein the integrated intensity of said x-ray diffraction angle peak is greater than 4 percent of the total diffraction pattern intensity, after background subtraction. Since such heat-treated fibers have already been exposed to an environment of 260° C. or higher, and when formed papers comprising those heat-treated fibers made from the first polymer; that is, the copolymer described above, and polymeric binder made from the second polymer; that is, the copolymer described above, are then thermally consolidated or calendered, the resulting papers exhibit a x-ray diffraction angle peak and intensity similar to the heat-treated fibers; that is, such papers made from heat-treated fibers exhibit an x-ray diffraction angle tracing showing a 2 theta (2θ) x-ray diffraction angle peak of 20.2 (+/−0.5) degrees, and wherein the integrated intensity of that peak is greater than 4 percent of the total diffraction pattern intensity, after background subtraction. Again, tracing 2 of FIG. 1 is an illustration of representative x-ray diffraction angle tracings and of paper and fiber having a 2 theta (2θ) x-ray diffraction angle peak at 20.2 (+/−0.5) degrees, which is representative of both the heat-treated fibers and papers made from such heat-treated fibers.

The X-ray peaks and intensities of different fibers and papers are summarized in the Reference Table.

Reference Table

| | X-Ray Peak | Intensity |
|---|---|---|
| Item | (+/−0.5) | (%) |
| Dried Fiber | 25 | >/=25 |
| Uncalendered Paper-Dried Fiber | 25 | >/=25 |
| Calendered Paper-Dried Fiber | 20.2 | </=4 |
| Heat Treated (HT) Fiber | 20.2 | >4 |
| Uncalendered Paper-HT Fiber | 20.2 | >4 |
| Calendered Paper-HT Fiber | 20.2 | >4 |

Therefore, the inventive papers comprise polymeric fibers and polymeric binder, the polymeric fibers comprising a first polymer and the polymeric binder comprising a second polymer, wherein both the first and second polymer is a copolymer having a structure derived from the reaction of para-oriented aromatic diamine monomer and benzimidazole monomer with a para-oriented aromatic diacid monomer; the papers having a dielectric strength of 12.0 kV/mm or greater, an average specific modulus of 8000 Pa-m³/g or higher, and a density of 0.75 grams per cubic centimeter or greater, the papers additionally having a 2 theta (2θ) x-ray diffraction angle peak of 20.2 (+/−0.5) degrees, and the integrated intensity of said x-ray diffraction angle peak is 4 percent or less of the total diffraction pattern intensity, after background subtraction.

As shown in the examples herein, it is believed that this surprising combination of high average specific thickness, density, and dielectric properties result from the use of the “dried” copolymer fibers in the formation of the papers, which can provide a thermally consolidated paper that has fiber components that are more efficiently bonded or bound together. The result is a paper having the combination of higher density, higher dielectric strength, and higher average specific modulus than papers made the same way from either “heat treated” aramid copolymer fibers, or papers made with either homopolymer poly(paraphenylene terephthalate) fibers (PPD-T fibers) or papers made with homopolymer poly(metaphenylene isophthalamide) fibers (MPD-I fibers).

This invention also relates to processes for making the inventive paper, which can comprise the steps of:
a) forming an aqueous slurry comprising polymeric fibers comprising a first polymer and polymeric binder comprising a second polymer,
   wherein the first polymer is a copolymer having a structure derived from the reaction of para-oriented aromatic diamine monomer and benzimidazole monomer with a para-oriented aromatic diacid monomer, and the polymeric fibers have a 2 theta (2θ) x-ray diffraction angle peak of 25 (+/−0.5) degrees, and
   wherein the second polymer is a copolymer having a structure derived from the reaction of para-oriented aromatic diamine monomer and benzimidazole monomer with a para-oriented aromatic diacid monomer;
b) removing water from the slurry on a paper machine to form a wet paper composition;
c) drying the wet paper composition to form a dried sheet; and
d) thermally consolidating the dried sheet in one or more steps between nipped rolls heated to a surface temperature of 260° C. or more, using a nip pressure of 700 to 5000 lbs./inch (125 to 894 kg/cm);
to form a paper having a dielectric strength of 12.0 kV/mm or greater, an average specific modulus of 8000 Pa-m³/g or higher, and a density of 0.75 grams per cubic centimeter or greater.

The aqueous slurry of polymeric fibers used in step a) contains “dried fibers” as defined herein made from the first polymer. These dried fibers have not been exposed to any environment of 260° C. or higher. Consequently, these dried fibers have a 2 theta (2θ) x-ray diffraction angle peak of 25 (+/−0.5) degrees. In some embodiments, the dried fibers have an x-ray diffraction angle tracing showing a 2 theta (2θ) x-ray diffraction angle peak of 25 (+/−0.5) degrees, and the integrated intensity of said x-ray diffraction angle peak is 25 percent or more of the total diffraction pattern intensity, after background subtraction. The formed paper prior to thermal consolidation has essentially this same x-ray diffraction angle peak and the integrated intensity.

The thermal consolidation in step d) exposes the fibrous material in the formed paper to high temperatures (260° C. or more) and pressure, creating a paper having a dielectric strength of 12.0 kV/mm or greater, an average specific modulus of 8000 Pa-m³/g or higher, and a density of 0.75 grams per cubic centimeter or greater.

In some embodiments the paper after thermal consolidation has an x-ray diffraction angle tracing showing a 2 theta (2θ) x-ray diffraction angle peak of 20.2 (+/−0.5) degrees, the integrated intensity of said x-ray diffraction angle peak being 4 percent or less of the total diffraction pattern intensity, after background subtraction. In other words, both the x-ray diffraction angle peak and the integrated intensity of the formed paper changes as a result of thermal consolidation which involves exposure to temperatures of 260° C. or more.

As shown in the examples, this is not the case if the aqueous slurry of polymeric fibers used in step a) contains “heat-treated” fibers as defined herein made from the first polymer; that is, fibers that have already been exposed to high temperatures (260° C. or more) in the manufacture of those fibers prior to their use in papermaking. As shown in the Reference Table, those “heat-treated” fibers have an x-ray diffraction angle tracing showing a 2 theta (2θ) x-ray diffraction angle peak of 20.2 (+/−0.5) degrees, and the integrated intensity of said x-ray diffraction angle peak is more than 4 percent of the total diffraction pattern intensity (after background subtraction), and the formed paper made with the “heat treated” fibers has essentially this same x-ray diffraction angle peak and the integrated intensity. Additionally, as also shown in the Reference Table, because the “heat-treated” fibers have already been exposed to high temperatures, thermal consolidation of the formed paper with high temperatures (260° C. or more) and pressure does not have the same effect on those fibers in the paper, and an x-ray diffraction angle tracing of such paper retains the 2 theta (2θ) x-ray diffraction angle peak of 20.2 (+/−0.5) degrees, and while the integrated intensity of said x-ray diffraction angle peak changes slightly, it is maintained at more than 4 percent of the total diffraction pattern intensity, after background subtraction.

In some embodiments, an aqueous slurry containing the desired paper composition is supplied to a screen or wire mesh belt, where the solid materials in the slurry form a wet laid web, or what is sometimes known as a waterleaf, and the water is removed by gravity, vacuum, and/or pressing. The wet laid web, when dried using a conventional papermaking dryer section (typically on dryer rolls or in an oven at temperatures greater than 100° C. generally up to about 150° C., but significantly below 260° C.), becomes a dried paper (or “dried sheet” or “formed paper” as used interchangeably herein).

Reference may be made to Gross, (U.S. Pat. No. 3,756,908) and Hesler et al. (U.S. Pat. No. 5,026,456) for illustrative known processes for forming the dried sheet or formed paper. Once the dried sheet is formed, it can be thermally consolidated using a plate press, but for practical commercial production the thermal consolidation can be performed in a continuous manner by calendering the dried sheet in a nip between two heated calendering rolls, which applies high temperature and pressure to the dried sheet. If desired, several plies of the dried sheet with the same or different compositions can be combined together and thermally consolidated into the final paper structure.

The thermal consolidation of the dried sheet can be accomplished in one or more steps between heated surfaces, such as the nipped calender roll surfaces or a press plate surface, heated to a surface temperature of 260° C. or more, using a nip pressure of 700 to 5000 lbs./inch (125 to 894 kg/cm). In some embodiments, the nip pressure is 1500 to 5000 lbs./inch (268 to 894 kg/cm). In some embodiments, the nip pressure is 1500 to 3000 lbs./inch (268 to 535 kg/cm). In some embodiments, the surface can be heated to a surface temperature can be 260° C. to 450° C. In some embodiments, the surface can be heated to a surface temperature of 300° C. to 425° C. In some embodiments, the surface can be heated to a surface temperature of 350° C. to 425° C.

All of the additional features, elements, compositions, and properties of the paper or ingredients of the paper previously described herein; for example, dielectric strength, average specific modulus, tensile modulus, density, thickness, etc., apply to the features, elements, and properties recited for the process for making the paper.

Specifically, as previously discussed herein, the process for making the paper utilizes polymeric fibers comprising a first polymer as previously described herein and polymeric binder comprising a second polymer as previously described herein. That first polymer can comprise benzimidazole monomer that is 5(6)-amino-2-(p-aminophenyl) benzimidazole, para-oriented diamine monomer that is paraphenylene diamine, and para-oriented aromatic acid monomer that is terephthaloyl dichloride. Likewise, the second polymer can comprise benzimidazole monomer that is 5(6)-amino-2-(p-aminophenyl) benzimidazole, para-oriented diamine monomer that is paraphenylene diamine, and para-oriented aromatic acid monomer that is terephthaloyl dichloride.

In some embodiments, the binder includes non-granular polymer fibrids that are fibrous, film-like or a mixture thereof, made from the second polymer, which is preferably the aramid copolymer having a structure derived from the reaction of para-oriented aromatic diamine monomer and benzimidazole monomer with a para-oriented aromatic diacid monomer; with the most preferred embodiments the second polymer comprises benzimidazole monomer that is 5(6)-amino-2-(p-aminophenyl) benzimidazole, para-oriented diamine monomer that is paraphenylene diamine, and para-oriented aromatic acid monomer that is terephthaloyl dichloride.

In some embodiments, the aqueous slurry has polymeric fibers comprising the first polymer and polymeric binder comprising the second polymer, wherein the polymeric fibers comprising the first polymer are at least 40 weight percent of the combined weight of said polymeric fibers and said polymeric binder in the aqueous slurry; and in some embodiments, the polymeric fibers comprising the first polymer are at least 45 weight percent of the combined weight of said polymeric fibers and said polymeric binder in the aqueous slurry; and in some embodiments, the polymeric fibers comprising the first polymer are at least 50 weight percent of the combined weight of said polymeric fibers and said polymeric binder in the aqueous slurry.

In some specific embodiments, the aqueous slurry has 40 to 90 weight percent of the polymeric fibers comprising the first polymer and 10 to 60 weight percent of the polymeric binder comprising the second polymer, based on the combined weight of said polymeric fibers and said polymeric binder in the aqueous slurry. In some embodiments the aqueous slurry has 45 to 90 weight percent of the polymeric fibers comprising the first polymer and 10 to 55 weight percent of the polymeric binder comprising the second polymer, based on the combined weight of said polymeric fibers and said polymeric binder in the aqueous slurry. In some embodiments the aqueous slurry has 45 to 85 weight percent of the polymeric fibers comprising the first polymer and 15 to 55 weight percent of the polymeric binder comprising the second polymer, based on the combined weight of said polymeric fibers and said polymeric binder in the aqueous slurry. In some embodiments the aqueous slurry has 50 to 80 weight percent of the polymeric fibers comprising the first polymer and 20 to 50 weight percent of the polymeric binder comprising the second polymer, based on the combined weight of said polymeric fibers and said polymeric binder in the aqueous slurry.

The inventive papers have good electrical insulative properties and are suitable for use as electrical insulation. The inventive papers also have very good mechanical properties that are useful in composite applications including such things as honeycomb and other types of core material; along with any number of other applications requiring thermally stable high strength performance and high stiffness.

### Test Methods

Dielectric Strength. Dielectric Strength was measured according to ASTM D149-97A and reported in V/mil or kV/mm using 20.3 cm by 20.3 cm (8″ by 8″) test specimens pre-conditioned at 23 deg C. and 50% RH and tested with 5.08 cm (2″) flat electrodes at 20.6 deg C. and 60% RH. Some specimens have also been tested with 6.35 mm (0.25″) flat electrodes.

MD/XD Strength, MD/XD Modulus, & MD/XD Elongation. Tensile Strength, Young's Modulus, and Elongation in both the machine direction (MD) and the orthogonal cross direction (XD) were measured according to ASTM D 828-97 with 2.54 cm wide test specimens and a gage length of 18 cm and reported in MPa or N/cm and converted to GPa.

Density. Density was measured according to ASTM D792-20 and reported in kg/m³ and converted to g/cm³.

Average specific modulus. The Average specific modulus of a paper is the calculated average of the MD specific modulus and the XD specific modulus, reported in Pa·m³/g. The density of each of a MD paper sample and a XD paper sample is measured, and then the Young's Modulus in the machine direction (MD) and the Young's Modulus in the cross direction (XD) is determined. The MD specific modulus is then the Young's Modulus in the machine direction (MD) divided by the density of the MD paper sample; and the XD specific modulus is the Young's Modulus in the cross direction (XD) divided by the density of the XD paper sample. The MD specific modulus and the XD specific modulus are then averaged to calculate the average specific modulus.

Tensile Index. Tensile Index was measured according to ASTM D 828-97 with 2.54 cm wide test specimens and a gage length of 18 cm and reported in N·m/g.

X-Ray Diffraction. The molecular structure of papers and fibers was assessed with x-ray diffraction, using a Malvern Panalytical Materials Powder Diffractometer (MPD). Data were fit using an automated script written in MATLAB. Fiber samples were read on low background silicon wafers to avoid background discrepancies between samples. Data were first read in, then a scan of an empty sample holder was subtracted, such that the baseline on either side of the diffraction pattern was level after subtraction. Baseline leveling points were 7° and 59° two theta for meridional fiber data, 7.2° and 44° for equatorial fiber data. Next, a linear background was subtracted using the same endpoints to bring the baseline down to zero counts.

Thickness. Thickness was measured according to ASTM D374-99(2004) and reported in mils and converted to millimeters.

Base Weight. Basis Weight was measured according to ASTM D 646-96 and reported in g/m².

### Reference Example 1—Aramid Copolymer

The monomers 5(6)-amino-2-(p-aminophenyl) benzimidazole (DAPBI) and paraphenylene diamine (PPD), in amounts suitable for forming a copolymer having a DABPI/PPD monomer ratio of 70/30, were combined with a stoichiometric amount of terephthaloyl dichloride (TCI) in a solvent system comprising N-methyl-2-pyrrolidone (NMP) solvent and 4.5 weight percent calcium chloride (CaCl2) as a solubility enhancer. The monomers polymerized to form a copolymer. After the polymerization was complete, the copolymer crumb was recovered, ground, and washed with sodium hydroxide to neutralize byproduct hydrochloric acid. The crumb was then filtered and dried. The copolymer that had an inherent viscosity of about 6.45 dl/g. As reference, other copolymer techniques are disclosed in U.S. Pat. Nos. 9,988,514; 9,994,974; 10,400,082; 10,400,357; and 11,279,800.

### Reference Example 2—Aramid Copolymer Fibrids

For use in the preparation of fibrids, a polymer solution was then made from a portion of the dried polymer crumb by mixing 1.15 weight percent polymer, in 1.5 weight percent CaCl₂ solubility enhancer, 0.5 weight percent water, and 96.85 weight percent dimethyl acetamide (DMAc). Aramid copolymer fibrids were made by precipitation of the polymer under vigorous agitation that shears the solution to form filmy fibrous structures. The polymer was precipitated in a liquid system having 0.10 weight percent polymer, 0.14% weight percent calcium chloride, 8.8% weight percent DMAc, and 90.95% weight percent water. As reference, known techniques and apparatus are disclosed, for example, in U.S. Pat. Nos. 2,999,788; 3,756,908; and 3,018,091. The resulting fibrids were then washed in water to remove DMAc and calcium chloride. Fibrids resulting from this procedure exhibited a particle weighted length of about 600 microns.

### Reference Example 3—Aramid Copolymer Floc

The dried aramid copolymer floc and the heat-treated (HT) copolymer floc for use in the papers were made in the following manner. A portion of the dried polymer crumb made in Reference Example 1 was redissolved in sulfuric acid, to form a polymer solution suitable for spinning fibers. An aramid copolymer yarn of polymeric filaments was then spun from the polymer solution by extruding the polymer solution through a spinneret for form dope filaments, followed by air-gap spinning the dope filaments into a coagulation bath to remove sulfuric acid and form a yarn of filaments having nominal individual linear densities of 1.25 denier (1.39 dtex), followed by washing and drying of the yarn. As reference, known techniques are disclosed, for example, in U.S. Pat. Nos. 9,988,514; 9,994,974; 10,400,082; 10,400,357; and 11,279,800.

Using this process, aramid copolymer “dried fibers” were made by drying the aramid copolymer filament yarn only slightly above 100° C. and not subjecting the yarn to any additional heat treating; that is, it was not exposed to 260° C. or greater. Using this process, aramid copolymer “heat-treated fibers” were made by drying the aramid copolymer filament yarn as before, but additionally the aramid copolymer filament yarn was further heat treated by exposing the dried yarn to a temperature in excess of 260 C.

Yarn samples of both the “dried fibers” and the “heat-treated” fibers were then cut into 3 mm dried aramid copolymer floc using a Lummus cutter (available from DM&E Corporation) for use in the paper examples.

### Example 1

In the examples that follow, handsheet paper samples were made using the general instructions that follow, with the floc and fibrids being obtained as described in the Reference Examples and having the compositions and relative proportions as further described in Table 1. The floc had a nominal floc cut length of 3 mm. Each handsheet was prepared from a slurry of the floc and fibrids in water. Prior to combining the floc to the fibrids, the fibrids were dispersed in about 2 liters of water by shear mixing in a high shear laboratory mixer for 1 minute. Separately, the floc was dispersed in about 4 liters of water by shear mixing in a high shear laboratory mixer for 5 minutes. The fibrid slurry was then added to floc slurry and further mixed for 5 more minutes to achieve a slurry having uniformly dispersed solids in about 6 liters of water. The slurry was then added to the tank of paper hand-sheet equipment (TechPap® model FDA™ Automated Dynamic Handsheet Former) while maintaining mixing, and a paper handsheet measuring 10×36 inches (25.4 cm×91.44 cm) were prepared. The handsheet was then removed, placed between two pieces of blotting paper and hand-couched with a rolling pin to remove excess water, and then dried in a hand sheet dryer at 150° C. for 10 minutes. The handsheets were then conditioned an oven at 80° C. for 8 hours to remove moisture before densification. Each of the handsheets was then densified by pressing between nipped rollers at a temperature of 330° C. and a pressure of 800 lbs/in² (5.5×10⁶ N/m²).

In this and all other examples, handsheet paper samples were made, cut into testing samples as needed (e.g., machine direction (MD) and cross direction (XD), etc.), and individually tested. Inventive papers (1-1 to 1-5) contained dried aramid copolymer floc and aramid copolymer fibrids, while Comparative papers A-1 to A-5 contained heat-treated (HT) aramid copolymer floc and aramid copolymer fibrids. The paper compositions and properties are summarized in Tables 1-A & 1-B.

TABLE 1-A

| | | | | | | Average | |
|---|---|---|---|---|---|---|---|
| | | | | | | Specific | Dielectric |
| | Floc, | Fibrid, | | Fibrid | Density | Modulus | Strength, |
| Item | wt. % | wt. % | Floc Type | Type | (g/cm³) | (Pa · m³/g) | (kV/mm) * |
| 1-1 | 90 | 10 | Dried | Copolymer | 0.94 | 9701 | 13.7 |
| | | | Copolymer | | | | |
| 1-2 | 80 | 20 | Dried | Copolymer | 0.81 | 12229 | 13.2 |
| | | | Copolymer | | | | |
| 1-3 | 70 | 30 | Dried | Copolymer | 1.00 | 11144 | 17.2 |
| | | | Copolymer | | | | |
| 1-4 | 60 | 40 | Dried | Copolymer | 0.96 | 11424 | 19.9 |
| | | | Copolymer | | | | |
| 1-5 | 50 | 50 | Dried | Copolymer | 0.97 | 9976 | 18.7 |
| | | | Copolymer | | | | |
| A-1 | 90 | 10 | HT Copolymer | Copolymer | 0.36 | 8873 | 7.8 |
| A-2 | 80 | 20 | HT Copolymer | Copolymer | 0.45 | 12957 | 9.3 |
| A-3 | 70 | 30 | HT Copolymer | Copolymer | 0.39 | 11956 | 10.0 |
| A-4 | 60 | 40 | HT Copolymer | Copolymer | 0.38 | 14138 | 11.0 |
| A-5 | 50 | 50 | HT Copolymer | Copolymer | 0.46 | 10951 | 13.7 |

* Using ACDS 2″ flat electrode

TABLE 1-B

| | | | | | | Ultimate |
|---|---|---|---|---|---|---|
| | Basis | | Breaking | | | Tensile |
| | Weight | Thickness | Strength | Modulus | | Strength |
| | MD/XD | MD/XD | MD/XD | MD/XD | Directionality | Index |
| Item | (gsm) | (mm) | (N/cm) | (GPa) | (ratio) | (N · m/g) |
| 1-1 | 41.1/41.5 | 0.044/0.043 | 20.2/12.1 | 10.4/7.9 | 1.7 | 39.1 |
| 1-2 | 40.5/38.7 | 0.048/0.050 | 41.0/25.0 | 9.7/10.0 | 1.6 | 82.9 |
| 1-3 | 47.5/41.0 | 0.043/0.045 | 48.8/34.8 | 11.0/11.0 | 1.4 | 93.8 |
| 1-4 | 40.6/44.8 | 0.041/0.048 | 58.5/41.6 | 10.4/11.6 | 1.4 | 118.4 |
| 1-5 | 50.3/44.1 | 0.046/0.053 | 46.9/44.9 | 9.9/9.2 | 1.0 | 97.5 |
| A-1 | 43.7/41.0 | 0.117/0.117 | 11.9/12/3 | 3.7/2.8 | 1.0 | 28.6 |
| A-2 | 42.8/41.4 | 0.093/0.093 | 39.3/27.8 | 6.7/5.1 | 1.4 | 79.5 |
| A-3 | 45.9/39.7 | 0.109/0.109 | 32.0/21.8 | 5.0/4.4 | 1.5 | 62.3 |
| A-4 | 42.7/40.7 | 0.122/0.100 | 51.1/34.8 | 5.8/4.8 | 1.5 | 102.7 |
| A-5 | 53.6/39.7 | 0.099/0.107 | 59.9/30.4 | 7.4/3.0 | 2.0 | 94.1 |

### Example 2

X-ray diffraction angle tracings of the fibers and papers were obtained on fibers and papers made as described in the Reference Examples and Example 1. Table 2 describes the 2 theta (2θ) x-ray diffraction angle peak and integrated intensity after background subtraction for each fiber or paper measured.

TABLE 2

| | | Crystallinity | | | |
|---|---|---|---|---|---|
| | | Intensity | | ACS | |
| | | Major Peak % | | Major Peak | |
| | | 25° | 20° | 25° | 20° |
| Item | Description | (+/−0.5°) | (+/−0.5°) | (+/−3°) | (+/−3°) |
| R-1 | Dried (AS) | 30.1 | 0.0 | 25 | — |
| | Fiber | | | | |
| R-2 | Heat Treated | 0.0 | 7.1 | — | 28 |
| | (HT) Fiber | | | | |
| 2-1 | 100 wt. % | 0.0 | 1.7 | — | 32 |
| | Dried Fiber | | | | |
| | Calendered | | | | |
| | Paper | | | | |
| 2-A | 100 wt. % HT | 0.0 | 5.5 | — | 30 |
| | Fiber | | | | |
| | Calendered | | | | |
| | Paper | | | | |
| 2-2 | 80 wt. % Dried | 29.5 | 0.0 | 27 | — |
| | Fiber/20 | | | | |
| | wt. % Fibrids | | | | |
| | Uncalendered | | | | |
| | Paper | | | | |
| 2-3 | 80 wt. % | 0.0 | 2.5 | — | 30 |
| | Dried Fiber/ | | | | |
| | 20 wt. % Fibrids | | | | |
| | Calendered | | | | |
| | Paper | | | | |
| 2-B | 80 wt. % | 0.0 | 4.9 | — | 30 |
| | HT Fiber/ | | | | |
| | 20 wt. % Fibrids | | | | |
| | Uncalendered | | | | |
| | Paper | | | | |
| 2-C | 80 wt. % | 0.0 | 5.2 | | 30 |
| | HT Fiber/ | | | | |
| | 20 wt. % Fibrids | | | | |
| | Calendered | | | | |
| | Paper | | | | |

As shown in the Table 2, Reference Items R-1 & R-2 illustrate the change in crystallinity by heat-treating the dried fiber, and the associated change of the crystallinity peak and the Apparent Crystallite Size. Uncalendered paper made solely with the fibers of R-1 & R-2 would have essentially the same values as the fiber.

Crystallinity data for calendered papers made using solely the dried fiber are shown in Inventive Example 2-1 and Comparison Example 2-A; with the crystallinity of the dried fiber changing in the calendering step, while the crystallinity of the previously heat-treated fiber essentially not changing. However, as shown, the calendered paper using the dried fiber feedstock has crystallinity below the claimed intensity 4% or less.

Crystallinity data for uncalendered and calendered papers made with copolymer fibers that was “dried fiber” and polymeric fibrid binder is shown in Inventive Example 2-2 & 2-3 with crystallinity data for uncalendered and calendered papers made with the “heat-treated fiber” shown Comparison Example 2-B & 2-C. Again, the crystallinity of uncalendered paper made with the dried fiber is changed in calendering (thermal consolidation) while the crystallinity of the uncalendered paper made with the heat-treated fiber is barely affected by thermal consolidation. Additionally, the calendered paper using the “heat treated fiber” has a peak intensity of greater than 4%.

### COMPARISON EXAMPLES

A number of different papers were made as comparisons. All of the papers were made in a manner as described in Example 1, but with various flocs combined with meta-aramid fibrids as binders, specifically fibrids of poly (metaphenylene isophthalamide) (MPD-I). Comparison items A thru D used MPD-I fibrids combined with MPD-I floc or poly(paraphenylene terephthalamide) (PPD-T) floc. Comparison items E thru H used MPD-I fibrids combined with dried aramid copolymer floc or heat treated (HT) aramid copolymer floc.

The MPD-I fibrids were made using known techniques and apparatus, such as disclosed for example, in U.S. Pat. Nos. 2,999,788; 3,756,908; and 3,018,091. MPD-I fiber was made using the techniques and apparatus as disclosed in, for example, U.S. Pat. No. 3,756,908, by spinning yarns of filaments having a linear density of 2.2 denier (2.44 dtex) and subsequently exposing the MPD-I filament yarns to temperatures above the glass transition temperature of the MPD-I polymer, which formed crystallized MPD-I yarns. PPD-T filament yarns of 1.25 denier per filament (1.39 dtex per filament) was prepared by the process of U.S. Pat. No. 3,767,756 or U.S. Pat. No. 3,869,429; such yarns typically have filament tenacities of at least 18 gpd, (15.9 dN/tex) breaking elongation of at least 3.5 percent, and filament modulus of at least 400 gpd (353 dN/tex). The MPD-I and PPD-T filament yarn samples were then cut into 3 mm floc using a Lummus cutter.

All of the Comparison papers A thru H were thermally consolidated. Comparison papers A and B illustrate the properties of papers made with MPD-I floc and MPD-I fibrids. Comparison papers C & D illustrate the properties of papers made with poly (paraphenylene terephthalamide) (PPD-T) floc and MPD-I fibrids. Comparison papers E & F duplicate Items 1-2 & 1-5 of Example 1 and Comparison paper G & H duplicate Items A2 & A-5, all with the MPD-I fibrids substituted for the aramid copolymer fibrids.

For illustration, Comparison items I and H illustrate the properties of formed paper; that is, the paper prior to thermal consolidation, of a couple of the papers that were made with either MPD-I or PPD-T floc with MPD-I fibrids. These formed papers illustrate these papers are thicker and have low density, which is increased by thermal consolidation of the sheet with heat and pressure, as in a calendering or other pressing operation.

The properties of the papers are summarized in Tables 3A and 3B. None of these comparison papers have the combined desired high average specific modulus, dielectric strength, and density properties of the inventive papers.

TABLE 3A

| | | | | | | Avg. | |
|---|---|---|---|---|---|---|---|
| | | | | | | Specific | Dielectric |
| | Floc, | Fibrid, | | Fibrid | Density | Modulus | Strength, |
| Item | wt. % | wt. % | Floc Type | Type | (g/cm³) | (Pa · m³/g) | (kV/mm) * |
| A | 80 | 20 | MPD-I | MPD-I | 0.69 | 3054 | 9.0 |
| B | 50 | 50 | MPD-I | MPD-I | 0.76 | 3134 | 17.3 |
| C | 80 | 20 | PPD-T | MPD-I | 0.83 | 4084 | 10.0 |
| D | 50 | 50 | PPD-T | MPD-I | 0.86 | 5008 | 16.0 |
| E | 80 | 20 | Dried Copolymer | MPD-I | 0.71 | 5993 | 8.0 |
| F | 50 | 50 | Dried Copolymer | MPD-I | 0.77 | 6652 | 12.6 |
| G | 80 | 20 | HT Copolymer | MPD-I | 0.40 | 8212 | 7.7 |
| H | 50 | 50 | HT Copolymer | MPD-I | 0.62 | 9239 | 13.5 |
| I | 50 | 50 | MPD-I | MPD-I | 0.25 | 1561 | 7.1 |
| J | 80 | 20 | PPD-T | MPD-I | 0.17 | 199 | 4.3 |

* Using ACDS 2″ flat electrode

TABLE 3B

| | | | | | | Ultimate |
|---|---|---|---|---|---|---|
| | Basis | | Breaking | | | Tensile |
| | Weight | Thickness | Strength | Modulus | | Strength |
| | MD/XD | MD/XD | MD/XD | MD/XD | Directionality | Index |
| Item | (gsm) | (mm) | (N/cm) | (GPa) | (ratio) | (N · m/g) |
| A | 41.0/41.4 | 0.059/0.061 | 25.3/8.1 | 3.3/0.92 | 3.1 | 40.6 |
| B | 41.0/41.0 | 0.054/0.054 | 29.6/12.5 | 3.0/1.7 | 2.4 | 51.3 |
| C | 37.6/38.3 | 0.045/0.046 | 10.3/5.4 | 4.6/2.2 | 1.9 | 20.7 |
| D | 40.5/40.3 | 0.047/0.047 | 21.6/14.2 | 5.5/3.3 | 1.5 | 44.4 |
| E | 31.9/31.9 | 0.045/0.044 | 6.8/4.4 | 5.0/3.5 | 1.5 | 17.6 |
| F | 33.9/34.9 | 0.044/0.045 | 19.4/13.3 | 6.2/4.0 | 1.5 | 47.6 |
| G | 39.3/39.7 | 0.100/0.096 | 16.3/4.4 | 5.0/1.6 | 3.7 | 26.3 |
| H | 39.7/39.3 | 0.064/0.064 | 36.6/20.3 | 7.4/4.0 | 1.8 | 71.9 |
| I | 40.7/40.0 | 0.160/0.157 | 10.6/5.7 | 0.62/0.18 | 1.9 | 20.1 |
| J | 35.9/35.9 | 0.205/0.207 | 4.5/5.3 | 0.050/0.020 | 0.8 | 13.7 |

### Example 3

Selected inventive (2-1 to 2-2) and comparison (2-A to 2-E) thermally consolidated papers were re-made; however, a smaller diameter floc used in these papers. In these papers, the floc having a nominal size of 1.25 denier (1.39 dtex) per filament was replaced with a floc having a nominal size of 0.8 denier (0.9 dtex) per filament.

This illustrates the size (the linear density) of the floc is not the reason for the improved properties, as the trend is the same as for the larger floc.

TABLE 4A

| | | | | | | | Dielectric | |
|---|---|---|---|---|---|---|---|---|
| | | | | | | Average | Strength, | |
| | | | | | | Specific | (kV/mm) | |
| | Floc, | Fibrid, | Floc Type | | Density | Modulus | ACDS | ACDS |
| Item | wt. % | wt. % | (0.8 dpf) | Fibrid Type | (g/cm³) | (Pa · m³/g) | 2″ flat | 0.25″ flat |
| 2-1 | 80 | 20 | Dried Copolymer | Copolymer | 0.81 | 10585 | 19.5 | 21.6 |
| 2-2 | 50 | 50 | Dried Copolymer | Copolymer | 0.84 | 8396 | 24.4 | 27.9 |
| 2-A | 80 | 20 | HT Copolymer | Copolymer | 0.37 | 11519 | — | 8.6 |
| 2-B | 50 | 50 | HT Copolymer | Copolymer | 0.46 | 10617 | 12.4 | 14.4 |
| 2-C | 80 | 20 | PPD-T | MPD-I | 0.83 | 5400 | 13.0 | — |

TABLE 4B

| | | | | | | Ultimate |
|---|---|---|---|---|---|---|
| | Basis | | Breaking | | | Tensile |
| | Weight | Thickness | Strength | Modulus | | Strength |
| | MD/XD | MD/XD | MD/XD | MD/XD | Directionality | Index |
| Item | (gsm) | (mm) | (N/cm) | (GPa) | (ratio) | (N · m/g) |
| 2-1 | 22.4/20.3 | 0.028/0.025 | 15.5/11.5 | 10.1/7.1 | 1.3 | 62.7 |
| 2-2 | 22.7/21.7 | 0.028/0.024 | 17.2/10.0 | 7.7/6.4 | 1.7 | 60.9 |
| 2-A | 19.7/18.3 | 0.055/0.049 | 9.7/7.7 | 4.6/3.8 | 1.3 | 45.7 |
| 2-B | 15.6/17.0 | 0.035/0.036 | 9.7/11.4 | 5.2/4.5 | 0.9 | 64.7 |
| 2-C | 44.1/43.4 | 0.053/0.052 | 11.0/9.0 | 4.8/4.2 | 1.2 | 22.9 |

1. A paper comprising polymeric fibers, and polymeric binder, the polymeric fibers comprising a first polymer and the polymeric binder comprising a second polymer,
wherein the first polymer is a copolymer having a structure derived from the reaction of para-oriented aromatic diamine monomer and benzimidazole monomer with a para-oriented aromatic diacid monomer, and
wherein the second polymer is a copolymer having a structure derived from the reaction of para-oriented aromatic diamine monomer and benzimidazole monomer with a para-oriented aromatic diacid monomer,
the paper having a dielectric strength of 12.0 kV/mm or greater, an average specific modulus of 8000 Pa-m³/g or higher, and a density of 0.75 grams per cubic centimeter or greater.

2. The paper of claim 1, wherein the benzimidazole monomer of the first polymer is 5(6)-amino-2-(p-aminophenyl) benzimidazole.

3. The paper of claim 1, wherein the para-oriented diamine monomer of the first polymer is paraphenylene diamine.

4. The paper of claim 1, wherein the para-oriented aromatic acid monomer of the first polymer is terephthaloyl dichloride.

5. The paper of claim 1, wherein the benzimidazole monomer of the second polymer is 5(6)-amino-2-(p-aminophenyl) benzimidazole.

6. The paper of claim 1, wherein the para-oriented diamine monomer of the second polymer is paraphenylene diamine.

7. The paper of claim 1, wherein the para-oriented aromatic acid monomer of the second polymer is terephthaloyl dichloride.

8. The paper of claim 1, wherein the first and second polymer are the same polymer.

9. The paper of claim 1 comprising 40 to 90 weight percent of the polymeric fibers comprising the first polymer and 10 to 60 weight percent of the polymeric binder comprising the second polymer, based on the combined weight of said polymeric fibers and said polymeric binder.

10. The paper of claim 1, wherein the polymeric binder includes non-granular polymer fibrids that are fibrous, film-like or a mixture thereof, made from the second polymer.

11. The paper of claim 1, wherein the paper has a 2 theta (2θ) x-ray diffraction angle peak of 20.2 (+/−0.5) degrees, the integrated intensity of said x-ray diffraction angle peak being 4 percent or less of the total diffraction pattern intensity, after background subtraction.

12. A process for making a paper, comprising the steps of
a) forming an aqueous slurry comprising polymeric fibers comprising a first polymer and polymeric binder comprising a second polymer,
wherein the first polymer is a copolymer having a structure derived from the reaction of para-oriented aromatic diamine monomer and benzimidazole monomer with a para-oriented aromatic diacid monomer, and the polymeric fibers have a 2 theta (2θ) x-ray diffraction angle peak of 25 (+/−0.5) degrees, and
wherein the second polymer is a copolymer having a structure derived from the reaction of para-oriented aromatic diamine monomer and benzimidazole monomer with a para-oriented aromatic diacid monomer;
b) removing water from the slurry on a paper machine to form a wet paper composition;
c) drying the wet paper composition to form a dried sheet; and
d) thermally consolidating the dried sheet in one or more steps between nipped rolls heated to a surface temperature of 260° C. or more, using a nip pressure of 700 to 5000 lbs./inch (125 to 894 kg/cm);
to form a paper having a dielectric strength of 12.0 kV/mm or greater, an average specific modulus of 8000 Pa-m³/g or higher, and a density of 0.75 grams per cubic centimeter or greater.

13. The process of claim 12, wherein the first polymer comprises benzimidazole monomer that is 5(6)-amino-2-(p-aminophenyl) benzimidazole, para-oriented diamine monomer that is paraphenylene diamine, and para-oriented aromatic acid monomer that is terephthaloyl dichloride.

14. The process of claim 12, wherein the second polymer comprises benzimidazole monomer that is 5(6)-amino-2-(p-aminophenyl) benzimidazole, para-oriented diamine monomer that is paraphenylene diamine, and para-oriented aromatic acid monomer that is terephthaloyl dichloride.

15. The process of claim 12, wherein the first polymer comprises benzimidazole monomer that is 5(6)-amino-2-(p-aminophenyl) benzimidazole, para-oriented diamine monomer that is paraphenylene diamine, and para-oriented aromatic acid monomer that is terephthaloyl dichloride; and wherein the second polymer comprises benzimidazole monomer that is 5(6)-amino-2-(p-aminophenyl) benzimidazole, para-oriented diamine monomer that is paraphenylene diamine, and para-oriented aromatic acid monomer that is terephthaloyl dichloride.

16. The process of claim 12, wherein the first and second polymer are the same polymer.

17. The process of claim 12, wherein in step a) the slurry comprises 40 to 90 weight percent of the said polymeric fibers comprising the first polymer and 10 to 60 weight percent of said polymeric binder comprising a second polymer, based on the combined weight of the said polymeric fibers and said polymeric binder.

18. The process of claim 12, wherein the polymeric binder includes non-granular polymer fibrids that are fibrous, film-like or a mixture thereof, made from the second polymer.

19. The process of claim 12, wherein in step a),
the polymeric fibers have not been exposed to any environment of 260° C. or higher.

20. The process of claim 12, wherein the paper has a 2 theta (2θ) x-ray diffraction angle peak of 20.2 (+/−0.5) degrees, the integrated intensity of said x-ray diffraction angle peak being 4 percent or less of the total diffraction pattern intensity, after background subtraction.
